(19) United States
(12) Patent Application Publication
(10) Pub. No.: US 2026/0131451 A1
(43) Pub. Date: May 14, 2026

(54) Autonomous Modular Robotic Cart Device

(71) Applicant: Pringle Technologies Incorporated, Edwards, IL (US)

(72) Inventor: Sudheer Sajja, Peoria, IL (US)

(21) Appl. No.: 18/946,666

(22) Filed: Nov. 13, 2024

(51) Int. Cl. B25J 5/00; B25J 9/08; B25J 9/16; B25J 13/08

(52) U.S. Cl. CPC B25J 5/007; B25J 9/08; B25J 9/161; B25J 13/087

(57) ABSTRACT

An autonomous modular robotic cart device comprising a robotic base and a modular housing structure. The robotic base includes sensors, cameras, a computing system, a steering mechanism, and a power source, enabling autonomous navigation within an environment. The modular housing structure, detachably coupled to the robotic base via corresponding attachment mechanisms, can be interchanged for various applications, including waste receptacles, shelving units, janitorial carts, nursing stations, billboard carriers, and linen carriers. The robotic base is programmed to map environments, avoid obstacles, and navigate autonomously to designated pickup and disposal locations.

### FIELD OF THE INVENTION

The present invention relates generally to an autonomous navigation robot cart device. More specifically, the present invention is a modular robotic cart comprising a robotic base and a modular unit.

### BACKGROUND OF THE INVENTION

Proper waste management is essential for maintaining sanitary conditions within facilities of all sizes. Typically, garbage is consolidated at designated collection points, such as hallways, office corners, or walkways, using trash cans. From these collection points, custodians and janitors are tasked with transporting the trash to assigned disposal points, where commercial garbage trucks collect it for removal. However, in large or heavily populated facilities, this process becomes increasingly labor-intensive and inefficient. Custodians often struggle with moving numerous heavy trash cans over considerable distances, leading to fatigue, reduced productivity, and a heightened risk of physical injury, such as back pain or musculoskeletal strain. These challenges not only impede the efficiency of garbage disposal but also increase operational costs due to longer processing times and potential healthcare claims.

In response to these issues, mobile and autonomous robotic devices have emerged as solutions to improve the efficiency of material transportation. These devices are equipped with robotic bases that house essential components such as processors, sensors, cameras, and actuators. Above the robotic base, a structure is typically installed to hold the transported materials. While these autonomous devices have proven effective in various industries, they are often designed with specific applications in mind. For instance, a tiered cart is optimized for use in restaurant settings, while a hollow, enclosed structure is tailored for shopping environments. This single-purpose design presents a significant limitation: users must purchase multiple specialized devices to accommodate different tasks, resulting in increased upfront costs and ongoing maintenance expenses.

Furthermore, traditional robotic carts lack the flexibility to adapt to changing needs within a facility. Industries often require different configurations of robotic devices for diverse applications. For example, a large facility might need one type of cart for transporting trash, another for stocking shelves, and yet another for carrying tools or equipment. The inability to reconfigure these devices for varied uses necessitates the purchase of multiple units, which not only increases financial burdens but also complicates storage, maintenance, and operational workflows.

Additionally, the prior art does not disclose solutions that address the integration of modular elements into robotic devices, enabling seamless interchangeability of functional components. The absence of such modularity restricts versatility and prevents facilities from leveraging a single robotic base for multiple tasks. As a result, current robotic devices are constrained by their singular purpose and fail to provide the adaptability and cost-effectiveness demanded by modern industries.

The present invention addresses these shortcomings by introducing an autonomous modular robotic cart device equipped with a robotic base and a modular unit. The robotic base serves as the foundation, housing critical components necessary for autonomous operation, such as sensors, cameras, and processors. The modular unit, which can be easily attached and detached from the robotic base, allows users to customize the device for various applications. This modular approach eliminates the need for purchasing multiple specialized devices, reducing both upfront and long-term costs.

For example, in one embodiment of the present invention, the disclosed invention functions as a mobile robotic trash can, enabling custodians to transport garbage from pickup (collection) locations to disposal locations with minimal effort by the user. In an alternate embodiment, the modular unit can be replaced with a structure designed for transporting tools, stocking inventory, or performing other facility management tasks. This modularity provides that the device can adapt to a wide range of functions, making the present invention a cost-effective and practical solution for industries requiring dynamic applications. In summary, the present invention overcomes the limitations of the prior art by combining an autonomous robotic base with an interchangeable modular unit, providing a highly versatile, cost-efficient, and user-friendly solution for diverse material transportation needs.

### BRIEF DESCRIPTION OF THE DRAWINGS

FIG. 1 is a perspective view of the present invention.

FIG. 2 is a profile view of the robotic base of the present invention.

FIG. 3 is a bottom view of the modular housing structure of the present invention.

FIG. 4 is a component table of the robotic base of the present invention.

FIG. 5 is a component table of the computing system of the present invention.

FIG. 6 is a component table of the at least one processor of the present invention.

FIG. 7 is a component table of the computer storage device of the present invention.

FIG. 8 is a component table of the plurality of sensors of the present invention.

FIG. 9 is a component table of the steering mechanism of the present invention.

FIG. 10 is an additional profile view of the robotic base of the present invention.

FIG. 11 is an additional bottom view of the modular housing structure of the present invention.

FIG. 12 is a component table of the modular unit of the present invention showing multiple embodiments.

FIG. 13 is a view of the waste receptacle of the present invention.

FIG. 14 is a table showing the methods executed within the present invention.

FIG. 15 is a process diagram of the method of establishing and navigating an environment of the present invention.

FIG. 16 is a process diagram of the first step of the method of establishing and navigating an environment of the present invention.

FIG. 17 is a process diagram of multiple embodiments of the fourth step of the method of establishing and navigating an environment of the present invention.

FIG. 18 is a process diagram of the method of avoiding obstacles of the present invention.

FIG. 19 is a process diagram of the method of autonomously navigating within a proximity of a user of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of an autonomous modular robotic cart device, embodiments of the present disclosure are not limited to use only in this context.

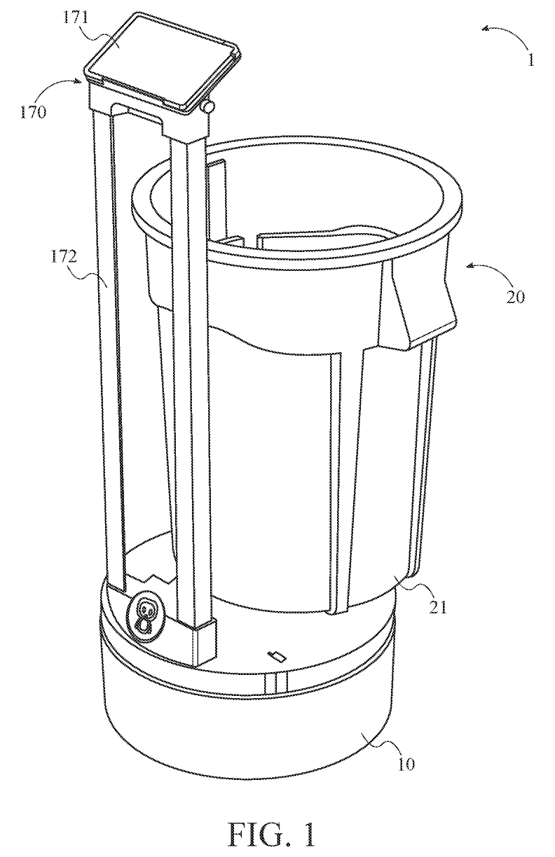

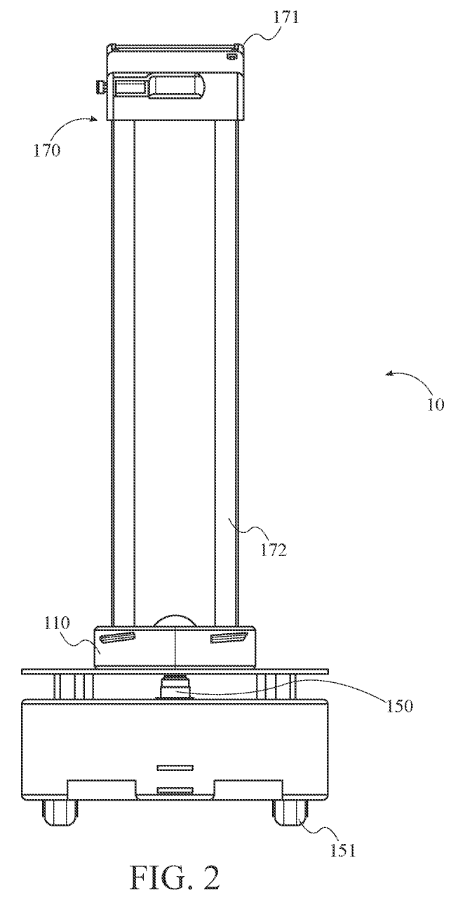

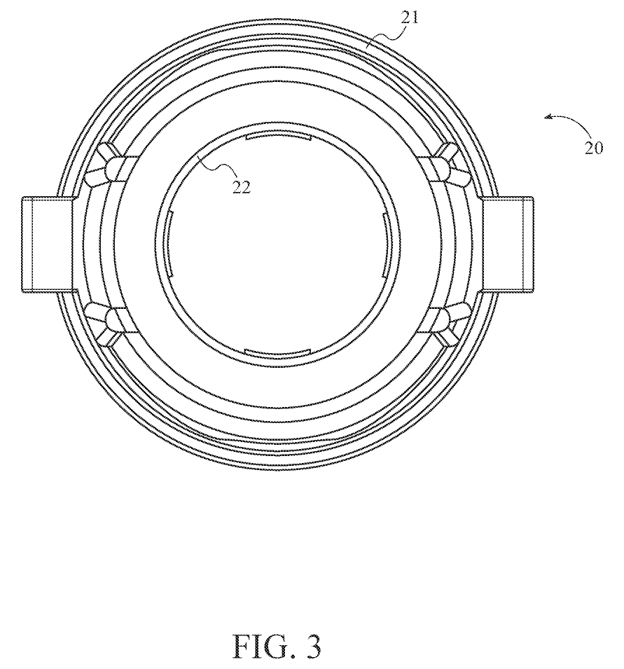

As shown in FIGS. 1-19, the present invention is an autonomous modular robotic cart device comprising a robotic base 10 and a modular housing structure 20. In the context of the present invention, the robotic base 10 and the modular housing structure 20 are adjustably coupled, wherein said modular housing structure 20 is modularly removable from the robotic base 10, as shown in FIG. 1. In the preferred embodiment of the present invention, the robotic base 10 comprises an attachment mechanism 110 and the modular housing structure 20 comprises an attachment mechanism 22 wherein said attachment mechanisms 110,22 are corresponding attachment mechanisms, as shown in FIG. 2 and FIG. 3, respectively. In the preferred embodiment of the present invention, the attachment mechanism 110 of the robotic base 10 is positioned on an upwardly facing, topmost surface of the robotic base 10.

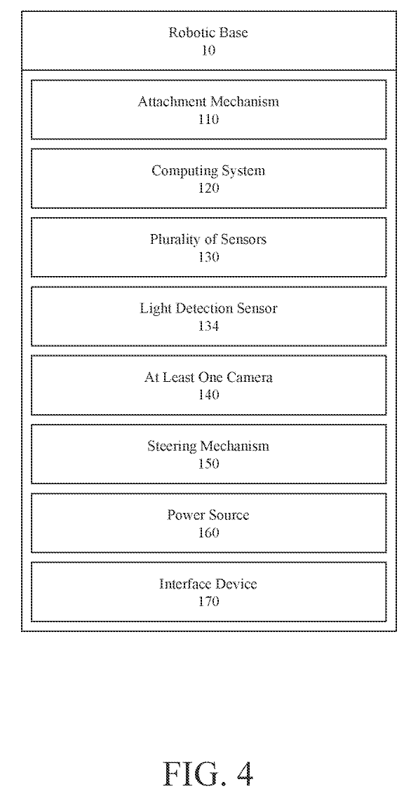

In the context of the present invention, the robotic base 10 is a programmable system integrated into a chassis designed to navigate within an environment. In the preferred embodiment of the present invention, as shown in FIG. 4, the robotic base 10 further comprises a computing system 120, a plurality of sensors 130, an at least one camera 140, a steering mechanism 150, a power source 160, and an interface device 170. In the context of the present invention, the computing system 120, the plurality of sensors 130, the at least one camera 140, the steering mechanism 150, the power source 160, and the plurality of sensors 130 are contained within a housing composing the robotic base 10.

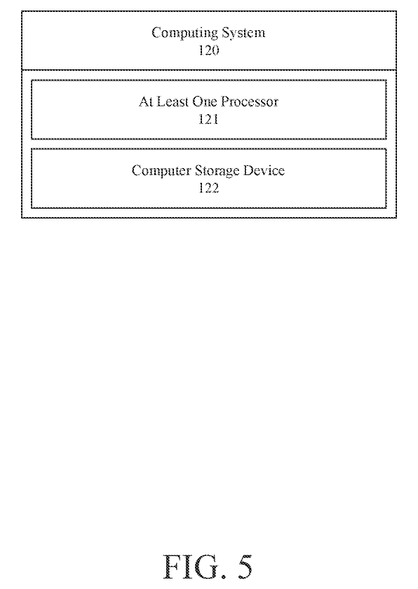

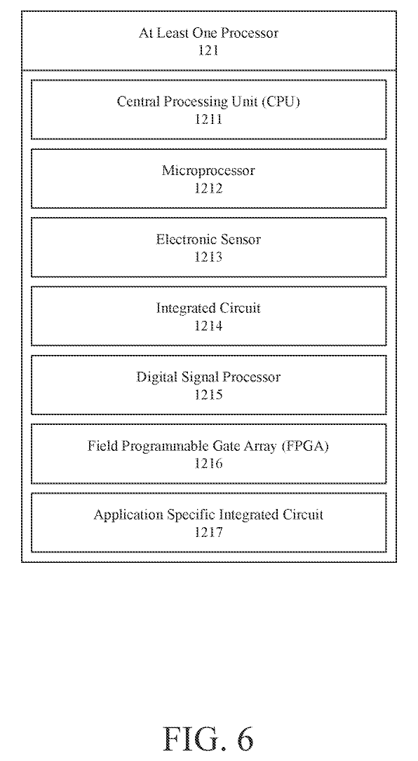

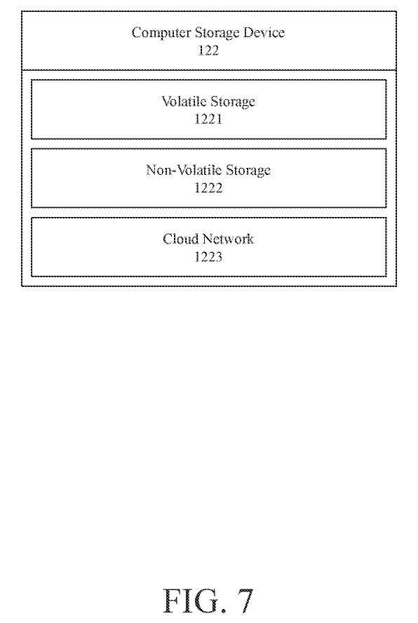

Furthermore, in the context of the present invention, as shown in FIG. 5, the computing system 120 comprises an at least one processor 121 and a computer storage device 122. In the preferred embodiment of the present invention, as shown in FIG. 6, the at least one processor 121 is selected from a central processing unit (CPU) 1211, a microprocessor 1212, an electronic sensor 1213, an integrated circuit 1214, a digital signal processor 1215, a field programmable gate array 1216, and an application specific integrated circuit 1217. In the context of the present invention, the at least one processor 121 is a device that receives and executes computer readable methods, functions, and instructions; performs logical operations; controls and coordinates communication between components disclosed herein; transfers and communicates data; and transfers data between input/output (I/O) devices. Furthermore, as shown in FIG. 7, within the context of the present invention, the computer storage device 122 is selected from a volatile memory storage device 1221, a non-volatile memory storage device 1222, and a cloud storage device 1223.

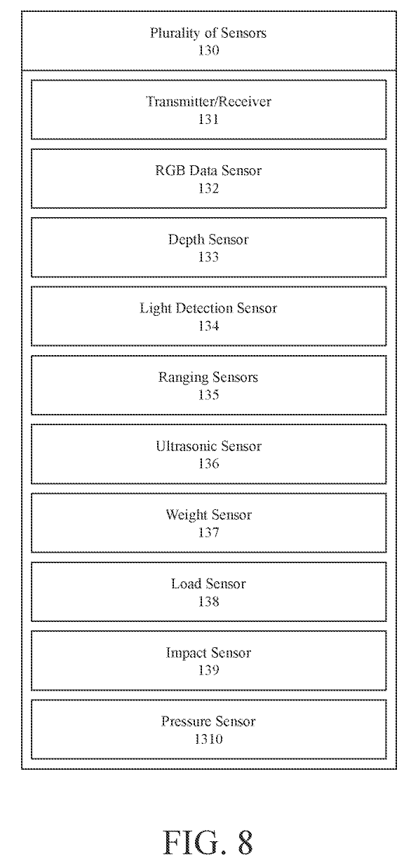

Additionally, in the preferred embodiment of the present invention, as shown in FIG. 8, the plurality of sensors 130 comprises a transmitter/receiver 131, a RGB data sensor 132, a depth sensor 133, a light detection sensor 134, a ranging sensor (LiDAR sensor) 135, an ultrasonic sensor 136, a weight sensor 137, a load sensor 138, an impact sensor 139, and a pressure sensor 1310. In some embodiments of the present invention, the robotic base 10 comprises a plurality of sensors 130, wherein said plurality of sensors 130 further comprises a plurality of any of the aforementioned sensors.

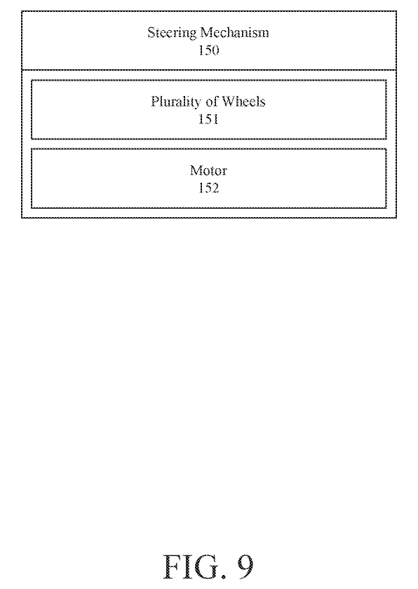

In the preferred embodiment of the present invention, the steering mechanism 150, as shown in FIG. 2 and FIG. 9, comprises a plurality of wheels 151 and a motor 152. In the context of the present invention, the motor 152 provides torque to the plurality of wheels 151 thereby rotating the said plurality of wheels 151, enabling the robotic base 10 to navigate through an environment along a ground surface. Additionally, in the context of the present invention, the power source provides power to the motor 152, thereby facilitating the torque applied the plurality of wheels 151. Further, the power source 160 provides power in the form of electricity throughout the robotic base 10. In the preferred embodiment of the present invention, the power source 160 is a battery.

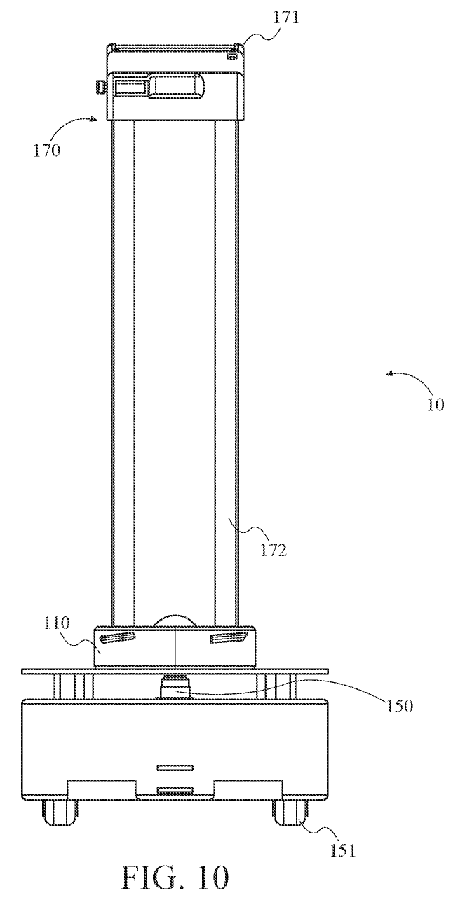

Moreover, as shown in FIG. 10, in the preferred embodiment of the present invention, the interface device 170 comprises an I/O device 171. In some embodiments of the present invention, the I/O device 171 is supported by a vertical support 172 wherein said vertical support 172 is interposed between the chassis of the robotic base 10 and the I/O device 171, enabling a user to access the interface device 170 while in a standing position. In some embodiments of the present invention, the I/O device 171 is a touchscreen device, a plurality of buttons, and a I/O devices of the like wherein said interface device 170 receives and facilitates inputs from a user and displays outputs to the user.

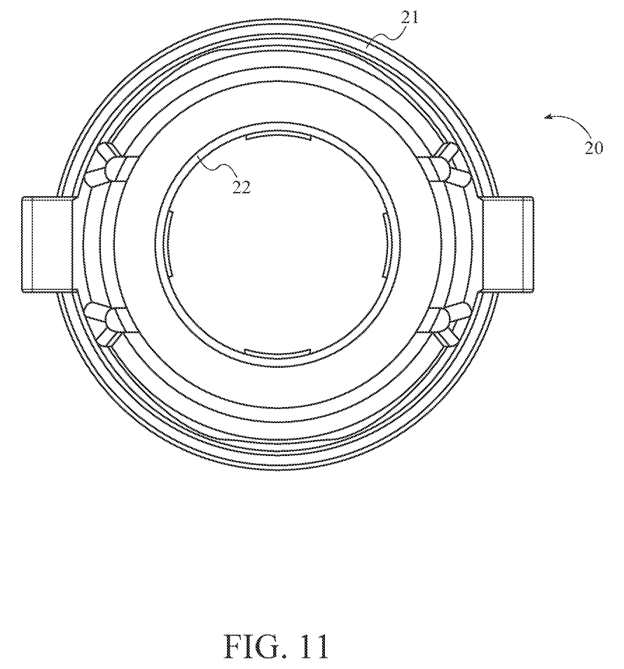

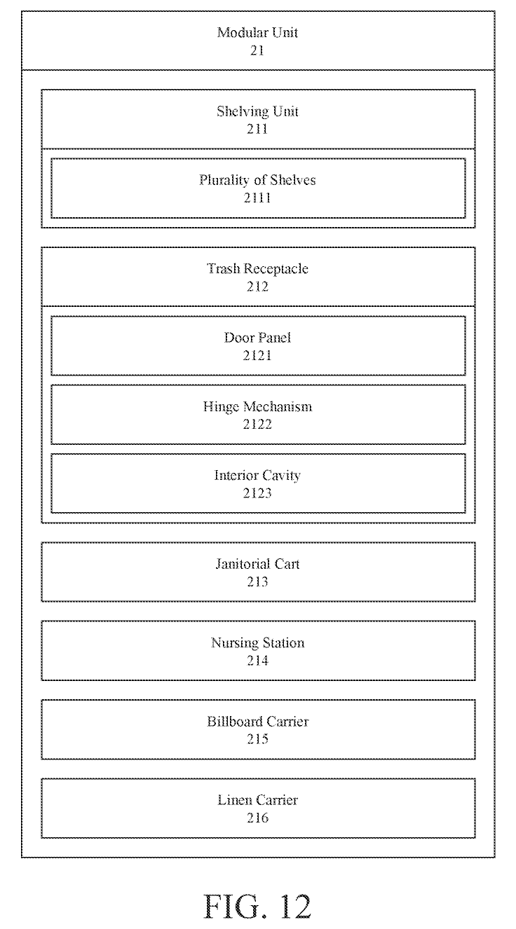

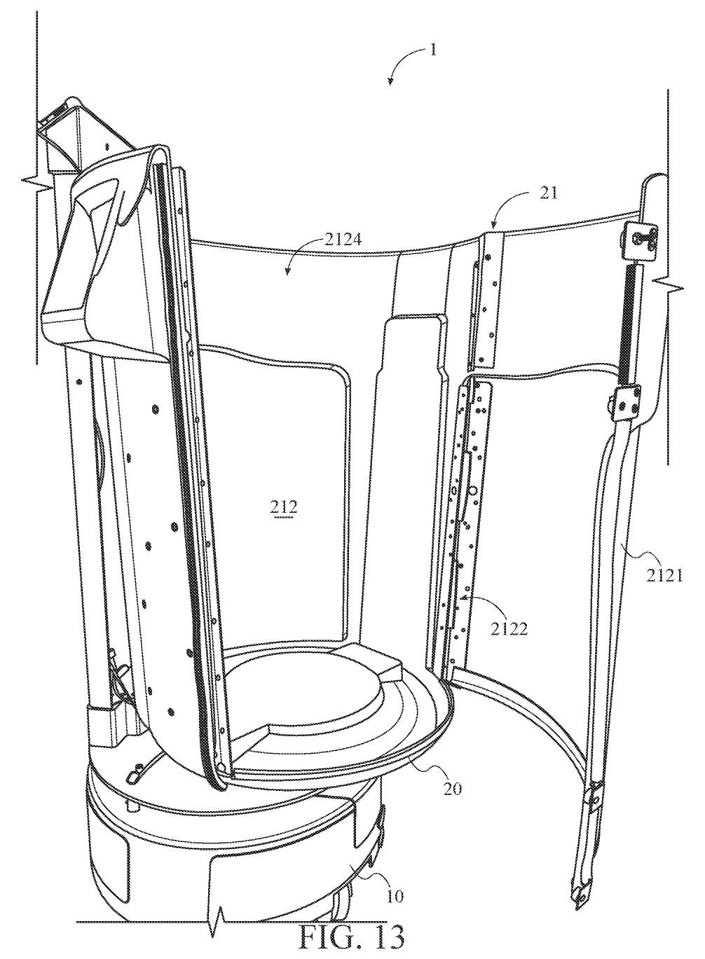

In the preferred embodiment of the present invention, as shown in FIG. 11, the modular housing structure 20 is composed of a modular unit 21 comprising the attachment mechanism 22. In the context of the present invention, the attachment mechanism 22 of the modular housing structure 20 is positioned on the bottom-facing surface of the modular unit 21, thereby coupling the bottom-facing surface of the modular unit 21 with the top-most surface of the robotic base 10. In the preferred embodiment of the present invention, as shown in FIG. 12, the modular unit 21 is selected from a shelving unit 211, a waste receptacle 212, a janitorial cart 213, a nursing station 214, a billboard carrier 215, and a linen carrier 216. In the context of the present invention, the shelving unit 211 comprises a plurality of horizontal panels (shelves) 211 and provides storage and organization for transporting items. In the context of the present invention, as shown in FIG. 13, the waste receptacle 212 is a bin comprising a door 2121, a hinge mechanism 2122, and a cavity 2124 wherein the door 2121 is hingedly coupled to the bin by way of the hinge mechanism 2122, providing adjustable access to the cavity 2124. In the preferred embodiment of the present invention, the door 2121 is coupled to the lateral side of the waste receptacle 212, thereby enabling a user to insert waste into the cavity 2124 without requiring the user to lift the waste bag the height of the present invention. In the context of the present invention, the janitorial cart 213 is a bin, thus providing storage for cleaning supplies and tools. Additionally, in the preferred embodiment of the present invention, the nursing station 214 is a structure providing organization for medical supplies and devices for facilitating patient care. Further, the billboard carrier 215, in the context of the present invention is an advertisement display. Lastly, in the context of the present invention, the linen carrier 216 is a bin designed to transport textile items.

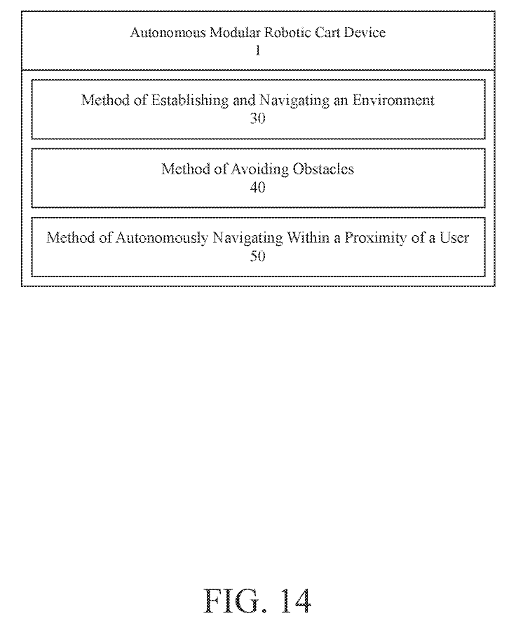

In the preferred embodiment, as shown in FIG. 14, the present invention comprises a method of establishing and navigating an environment 30, a method of avoiding obstacles 40, and a method of autonomously navigating within a proximity of a user 50.

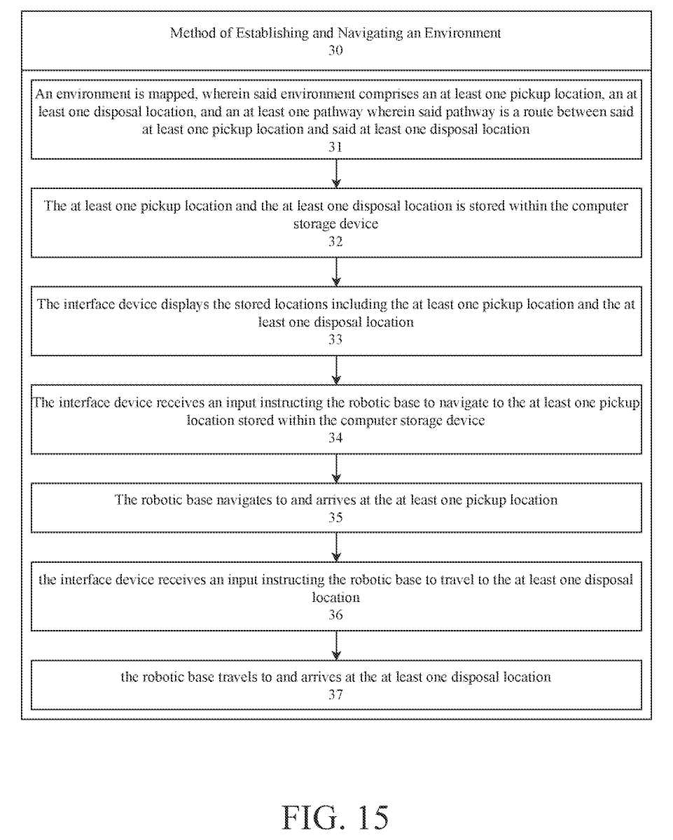

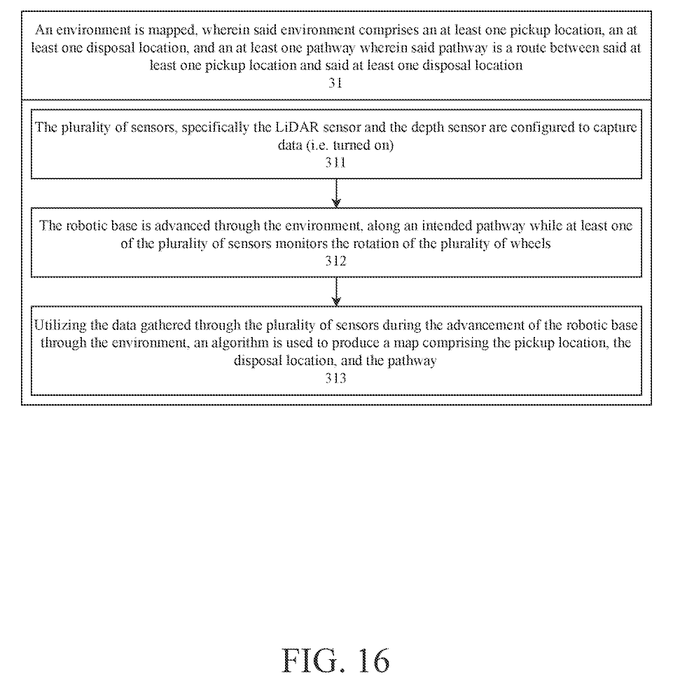

In the method of establishing and navigating an environment 30, as shown in FIG. 15, the present invention comprises a first step 31 (mapping) wherein an environment is mapped, wherein said environment comprises an at least one pickup location, an at least one disposal location, and an at least one pathway wherein said pathway is a route between said at least one pickup location and said at least one disposal location. In the context of the present invention, the pickup location is an initial location within the environment wherein the autonomous modular robotic cart device initiates the method of establishing and navigating an environment. Within the context of the present invention, the disposal location is a final destination within the environment wherein the autonomous modular robotic cart device navigates to from the pickup location. In the preferred embodiment of the present invention, during the first step 31, as shown in FIG. 16, the plurality of sensors 130, specifically the LiDAR sensor and the depth sensor capture 311 data (i.e. turned on). Next, within the mapping step, the robotic base 10 is advanced 312 through the environment, along an intended pathway while at least one of the plurality of sensors 130 monitors the rotation of the plurality of wheels 151. Then, utilizing the data gathered through the plurality of sensors 130 during the advancement of the robotic base 10 through the environment, an algorithm is used to produce 313 a map comprising the pickup location, the disposal location, and the pathway. In a second step 32 (storing) of the method of establishing and navigating an environment, the at least one pickup location and the at least one disposal location is stored within the computer storage device. In a third step 33 (displaying), the interface device 170 displays the stored locations including the at least one pickup location and the at least one disposal location. In a fourth step 34(receiving), the interface device 170 receives an input instructing the robotic base 10 to navigate to the at least one pickup location stored within the computer storage device. In a fifth step 35, the robotic base 10 navigates to and arrives at the at least one pickup location. In a sixth step 36, the interface device 170 receives an input instructing the robotic base 10 to travel to the at least one disposal location. In a seventh step 37, the robotic base 10 travels to and arrives at the at least one disposal location.

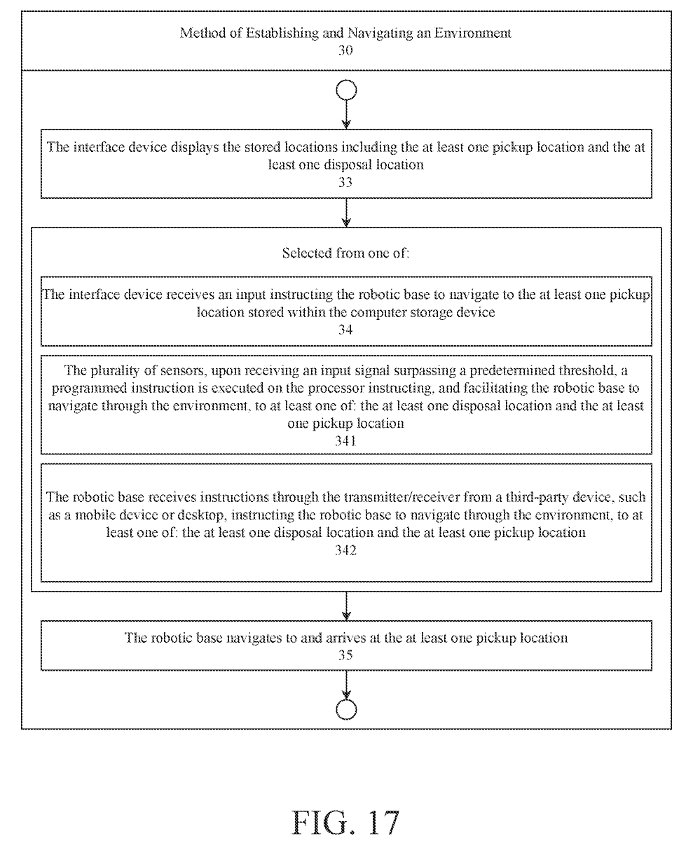

In some embodiments of the present invention, as shown in FIG. 17, the plurality of sensors 130, upon receiving an input signal surpassing a predetermined threshold, a programmed instruction is executed 341 on the at least one processor 121 instructing and facilitating the robotic base 10 to navigate through the environment, to at least one of: the at least one disposal location and the at least one pickup location. In such embodiments, at least one of the weight sensor 137, the load sensor 138, and the pressure sensor 1310 receive an input signal exceeding the predetermined threshold, thus initiating the navigation of the robotic base 10. Additionally, in some embodiments of the present invention, the robotic base 10 receives 342 instructions through the transmitter/receiver from a third-party device, such as a mobile device or desktop, instructing the robotic base 10 to navigate through the environment, to at least one of: the at least one disposal location and the at least one pickup location.

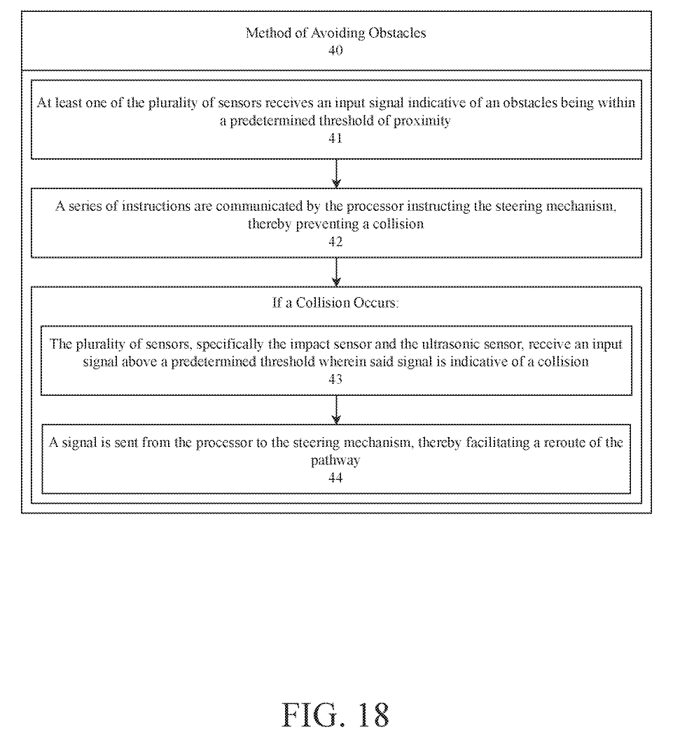

In the preferred embodiment of the present invention, the method of avoiding obstacles 40, as shown in FIG. 18, comprises a first step 41 wherein, upon traversing a first predetermined pathway, at least one of the plurality of sensors 130 receives an input signal indicative of an obstacle being within a predetermined threshold of proximity. In a second step 42, a series of instructions are communicated by the at least one processor 121 instructing the steering mechanism 150 to redirect along a second predetermined pathway, thereby preventing a collision. In an instance wherein a collision occurs, a third step 43 is initiated wherein the plurality of sensors 130, specifically the impact sensor 139 and the ultrasonic sensor 136, receive an input signal above a predetermined threshold wherein said signal is indicative of a collision. Upon execution of the third step 43, a fourth step 44 occurs wherein a signal is sent from the at least one processor 121 to the steering mechanism 150, thereby facilitating a redirection along a second predetermined pathway.

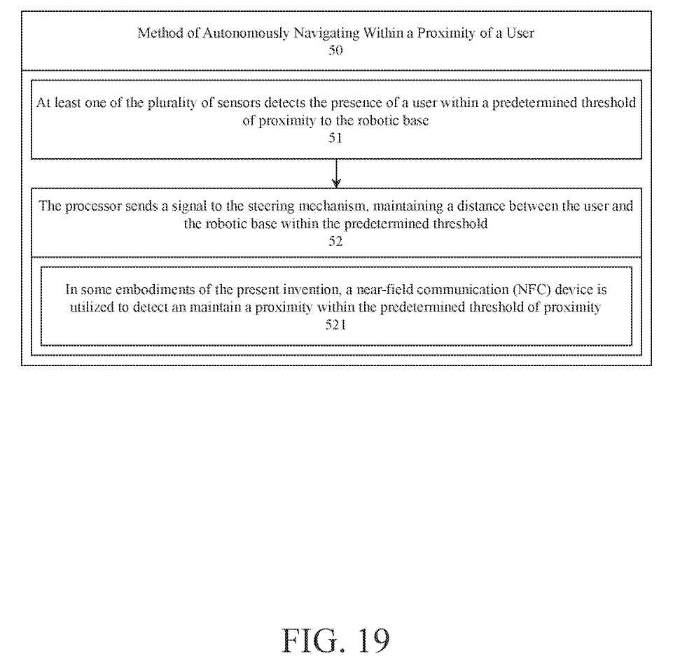

In the preferred embodiment of the present invention, as shown in FIG. 19, the method of autonomously navigating within a proximity of a user 50 comprises a first step 51 wherein at least one of the plurality of sensors 130 detects the presence of a user within a predetermined threshold of proximity to the robotic base 10. In a second step 52, the at least one processor 121 sends a signal to the steering mechanism 150, maintaining a distance between the user and the robotic base 10 within the predetermined threshold. In some embodiments of the present invention, a near-field communication (NFC) device is utilized 521 to detect and maintain a proximity within the predetermined threshold of proximity.

Although the invention has been explained in relation to its preferred embodiment, it is to be understood that many other possible modifications and variations can be made without departing from the spirit and scope of the invention.

What is claimed is:

1. An autonomous modular robotic cart device comprising:
a robotic base;
a modular housing structure;
wherein:
the robotic base comprises:
an attachment mechanism;
a computing system;
a plurality of sensors;
a steering mechanism; and
an interface device;
the modular housing structure comprises:
an attachment mechanism; and
a modular unit;
the robotic base and the modular housing structure detachably coupling wherein the attachment mechanism of the robotic base and the attachment mechanism of the modular housing structure are complimentary attachment mechanisms; and
the computing system, the plurality of sensors, the steering mechanism, and the interface device being housed within the robotic base.

2. The autonomous modular robotic cart device as claimed in claim 1, wherein the plurality of sensors comprises:
a transmitter;
a receiver;
a depth sensor;
a ranging sensor (LiDAR); and
an ultrasonic sensor.

3. The autonomous modular robotic cart device as claimed in claim 2, wherein the steering mechanism comprises a plurality of wheels and a motor.

4. The autonomous modular robotic cart device as claimed in claim 3 wherein the computing system comprises a processor and a computer storage device.

5. The autonomous modular robotic cart device as claimed in claim 4 wherein:
an environment is mapped wherein said environment comprises an at least one pickup location, an at least one disposal location, and an at least one pathway, whereby:
the LiDAR sensor and the depth sensor capture data;
the robotic base is advanced through the environment, along an intended pathway while at least one of the plurality of sensors monitors the rotation of the plurality of wheels; and
an algorithm is populated with data gathered by the plurality of sensors producing a map of said environment comprising the at least one pickup location, the at least one disposal location, and the at least one pathway.

6. The autonomous modular robotic cart device as claimed in claim 5 wherein the at least one pickup location and the at least one disposal location are stored within the computer storage device.

7. The autonomous modular robotic cart device as claimed in claim 6, wherein the interface device displays the at least one pickup location and the at least one disposal location.

8. The autonomous modular robotic cart device as claimed in claim 7 wherein the interface device receives an input instructing the robotic base to navigate to the at least one pickup location stored within the computer storage device.

9. The autonomous modular robotic cart device as claimed in claim 7 wherein:
the plurality of sensors further comprise a weight sensor, a load sensor, and a pressure sensor;
at least one of the weight sensor, the load sensor, and the pressure sensor receive an input signal exceeding a predetermined threshold; and
the processor instructs the robotic base to navigate through the environment, to at least one of: the at least one disposal location and the at least one pickup location.

10. The autonomous modular robotic cart device as claimed in claim 7 wherein the robotic base receives instructions through the transmitter/receiver from a third party device instructing the robotic base to navigate through the environment, to at least one of: the at least one disposal location and the at least one pickup location.

11. The autonomous modular robotic cart device as claimed in claim 6, wherein:
the robotic base navigates to and arrives at the at least one pickup location;
the robotic base receives an input instructing said robotic base to travel to the at least one disposal location; and
the robotic base travels to and arrives at the at least one disposal location.

12. An autonomous modular robotic cart device comprising:
a robotic base;
a modular housing structure;
wherein:
the robotic base comprises:
an attachment mechanism;
a computing system comprising a processor;
a plurality of sensors; and
a steering mechanism comprising a plurality of wheels and a motor;
the modular housing structure comprises:
an attachment mechanism; and
a modular unit;
the plurality of sensors comprising:
an impact sensor;
a depth sensor; and
an ultrasonic sensor;
the robotic base and the modular housing structure detachably coupling wherein the attachment mechanism of the robotic base and the attachment mechanism of the modular housing structure are complimentary attachment mechanisms; and
the computing system, the plurality of sensors, the steering mechanism, and the interface device being housed within the robotic base; and
the steering mechanism directing the robotic base from a pickup location to a disposal location, along a first predetermined pathway.

13. The autonomous modular robotic cart device, as claimed in claim 12 wherein at least one of the plurality of sensors receives an input signal indicative of an obstacle wherein said obstacle is denoted as being within a predetermined threshold of proximity.

14. The autonomous modular robotic cart device, as claimed in claim 13, wherein the processor instructs the steering mechanism to avoid the obstacle.

15. The autonomous modular robotic cart device, as claimed in claim 13, wherein the impact sensor and the ultrasonic sensor receive an input signal above a predetermined threshold wherein said signal is indicative of a collision.

16. The autonomous modular robotic cart device, as claimed in claim 15, wherein the processor communicates a signal to the steering mechanism, instructing said steering mechanism to redirect the robotic base along a second predetermined pathway.

17. An autonomous modular robotic cart device comprising:
a robotic base;
a modular housing structure;
wherein:
the robotic base comprises:
an attachment mechanism;
a computing system comprising a processor;
a plurality of sensors; and
a steering mechanism comprising a plurality of wheels and a motor;
the modular housing structure comprises an attachment mechanism;
the robotic base and the modular housing structure detachably coupling wherein the attachment mechanism of the robotic base and the attachment mechanism of the modular housing structure are complimentary attachment mechanisms;
the computing system, the plurality of sensors, the steering mechanism, and the interface device being housed within the robotic base;
the plurality of sensors acquiring input signals within a predetermined threshold of proximity; and
the steering mechanism directing the robotic base from a pickup location to a disposal location, along a first predetermined pathway.

18. The autonomous modular robotic cart device, as claimed in claim 17 wherein the plurality of sensors comprise:
an RGB data sensor;
a depth sensor;
a light detection sensor;
a ranging sensor (LiDAR); and
an ultrasonic sensor.

19. The autonomous modular robotic cart device as claimed in claim 18, wherein at least one of the plurality of sensors detects a user presence within a predetermined threshold of proximity to the robotic base

20. The autonomous modular robotic cart device as claimed in claim 19, wherein the processor sends a signal to the steering mechanism, maintaining a distance between the user and the robotic base within the predetermined threshold.
